(19) United States
(12) Patent Application Publication
(10) Pub. No.: US 2009/0320086 A1
(43) Pub. Date: Dec. 24, 2009

(54) Loss reduction in a coaxial network

(75) Inventors: Martinus Rijssemus, Heelsum (NL); Keith Mothersdale, Shipley (GB)

Correspondence Address: ABELMAN, FRAYNE & SCHWAB, 666 THIRD AVENUE, 10TH FLOOR, NEW YORK, NY, 10017, US

(73) Assignee: Technetix Group Limited

(21) Appl. No.: 12/456,705

(22) Filed: Jun. 18, 2009

Related U.S. Application Data
(60) Provisional application No. 61/132,906, filed on Jun. 23, 2008.

(51) Int. Cl. H04N 7/173

(52) U.S. Cl. 725/127

(57) ABSTRACT

An in-house coaxial network includes an input (10) capable of connection to a cable or satellite television signal provider and which is connected to a signal splitting device (12) for communicating the signal to a plurality of outlets in the form of subscriber equipment, wherein a filter (36: 38) is positioned between the input (10) and the signal splitting device (12). The filter is adapted to reflect signals outside a frequency pass band used for data transfer thereby to reduce signal loss. By reflecting signals outside the frequency pass band, whilst at the same time passing all signals in the frequency pass band, the filter (36: 38) significantly reduces the signal loss between the plurality of outlets (16).

### CROSS REFERENCE TO RELATED APPLICATION

This patent application claims the benefit of U.S. Provisional Application, Ser. No. 61/132,906, filed Jun. 23, 2008, the contents of which are incorporated by reference herein in its entirety.

### FIELD OF INVENTION

This invention relates to reducing signal loss in a coaxial network, and in particular an in-home coaxial network.

### BACKGROUND OF THE INVENTION

Coaxial networks suffer from signal loss which becomes worse as the network adds additional outlet points. Many homes have an in-home coaxial network installed to distribute TV signals to and from various locations around the home. This network can also be used to distribute data or other signals to and from these locations, in many cases parallel to the TV signals. However whilst there may be an access point within the home to the in-home coaxial network to which TV signals can be passed by a service provider connected to that input, signal losses in the in-home network can prevent the in-home network being operational where there are too many outlets to subscriber equipment, such as televisions and computers.

### SUMMARY OF THE INVENTION

In accordance with the present invention, there is provided a coaxial network, typically an in-house network or a network within a dwelling such as a flat, comprising an input capable of connection to a cable or satellite television signal provider and which is connected to a signal splitting device for communicating a signal to a plurality of outlets in the form of subscriber equipment, wherein a filter is positioned between the input and the signal splitting device, the filter adapted to reflect signals in a frequency band used for data transfer thereby to reduce signal loss. By reflecting signals in a frequency band used for data transfer, whilst at the same time passing all other signals in a frequency pass band, the filter significantly reduces the signal loss between the plurality of outlets.

Typically the coaxial network will include more than one splitting device in which case the filter is positioned between the input and a first splitting device, or splitter, from which signals to other splitting devices are derived.

Preferably the coaxial network is capable of parallel data transmission, for example of television signals and data signals used in computing equipment.

Preferably the filter is adapted to reflect signals inside a frequency range between 3 and 65 MHz or alternatively 900 to 1500 MHz, as these are the frequency bands generally used by radio frequency (RF) data technology. However the reflection characteristics of the filter may be varied dependent on the frequencies used in data transfer technology used in the network.

The invention is also suitable for use in coaxial networks used solely for the distribution of data, for example via a modem, and not for distribution of TV signals. In this instance, the filter terminates the input, whilst still reflecting all signals outside the frequency pass band.

The invention also lies in use of a filter positioned on an electrical communication path between a cable or satellite television signal provider and a splitter so as to reflect signals in a frequency band used for data transfer which are outside a frequency pass band, with the frequency pass band being the range of signal frequencies used by the cable or satellite television provider. The signals in the frequency band used for data transfer are those signals used for electronic communication inside the home.

### BRIEF DESCRIPTION OF THE DRAWINGS

The invention will now be described by way of example and with reference to the accompanying drawings in which:

FIG. 1 is a schematic representation of an in-home coaxial network;

FIG. 2 is a schematic diagram of an in-home coaxial network with parallel data transmission;

FIG. 3 is a schematic diagram of a splitter;

FIG. 4 is a schematic diagram of an un-terminated splitter;

FIG. 5 is a schematic diagram of a coaxial network in accordance with the present invention; and

FIG. 6 is a schematic diagram of a coaxial network in accordance with the invention used for the distribution of data.

To facilitate understanding of the invention, identical reference numerals have been used, when appropriate, to designate the same or similar elements that are common to the figures. Further, unless stated otherwise, the drawings shown and discussed in the figures are not drawn to scale, but are shown for illustrative purposes only.

### DETAILED DESCRIPTION OF THE INVENTION

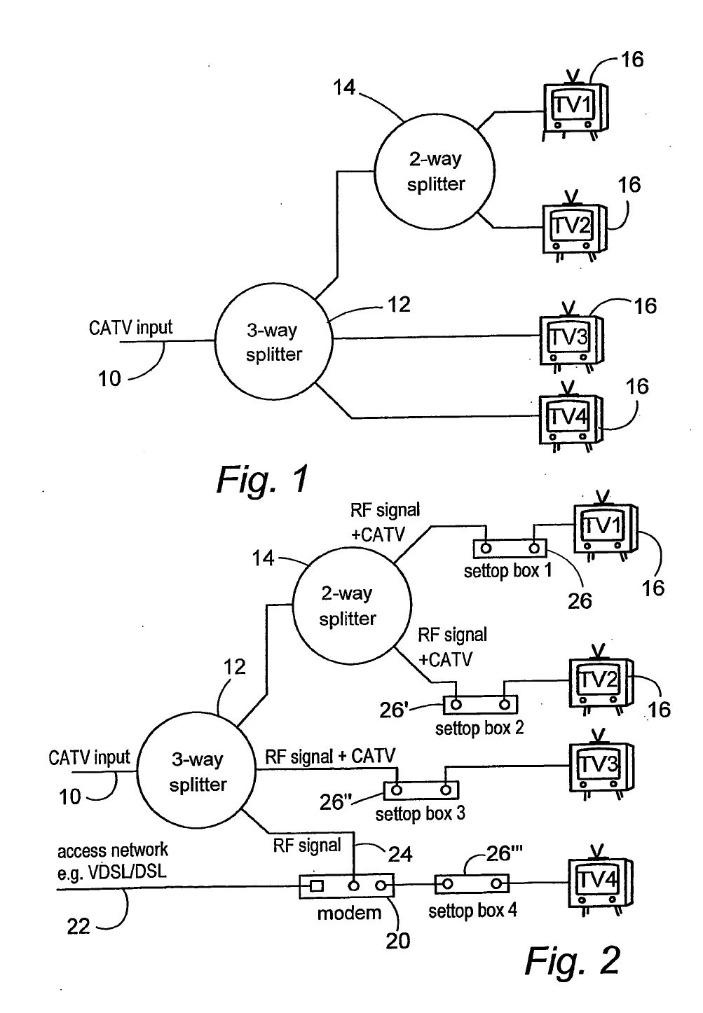

FIG. 1 shows a typical coaxial in-home TV network comprising an input 10 to which a cable television signal provider can connect, and splitters 12, 14 which split the signal to service a plurality of items of subscriber equipment 16, such as televisions. This network is built with a 3-way and a cascaded 2-way splitter 12, 14 to allow four television or radio sets 16 to be supplied with the signal from the cable television provider. This is just by way of example, as many other topologies using different combinations of splitters to supply a different number of outlets can be designed. No two in-home networks are the same and the number of television locations, the number of splitters and the location of splitters will vary from home to home. In many cases it is very difficult to get an accurate overview of the network as often there is no network topology available and the splitters can be hidden between walls or behind panels.

Such a network can be used as a data network as well by using radio frequency (RF) based technology, see for example the network shown in FIG. 2 where there is parallel data transmission of RF signals and cable television signals to each item of subscriber equipment. In this network, a modem 20 is connected to an access network 22, for example VDSL or DSL, with the modem 20 producing a data stream that is converted to an RF base signal 24, for example HPNA or MoCA. This radio frequency signal is connected to the in-home network via a 3-way splitter 12 and passes through splitters 12, 14 to set top boxes 26 attached to subscriber equipment 16. The set top boxes 26 transfer the RF signal to for example, video for television or provide a data stream, for example Ethernet, that can be used by a computer. Each item of subscriber equipment can communicate with each other item through the network to allow for maximum functionality and efficiency. However, electrical losses occur at each of the splitter ports and with numerous outlet ports, these losses can reach a level where the data speed of the network is significantly reduced, and in many cases prevented from working at all.

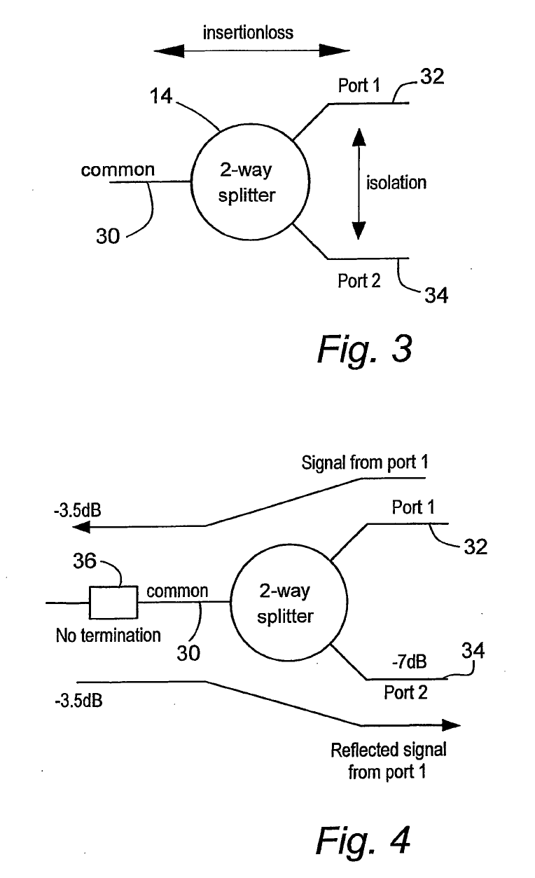

A basic cable television splitter 14 is shown in FIG. 3 with a common input port 30 and a first output port 32 and a second output port 34. The splitter has insertion loss from the common port 30 to the output ports 32,34 and when properly terminated at the common port 30, isolation between the outlet ports 32 and 34. Thus in the example shown of a standard 2-way splitter, it has an insertion loss of 3.5 dB from the common port 30 to both port 32 and port 34, while the isolation is typically around 30 dB to 40 dB between ports 32 and 34 depending on the quality of the splitter and the frequency used.

As can be seen from FIG. 2, the electrical communication path between the various locations is often from a splitter output port to another splitter output port. For example, the communication path between set top box 26 and set top box 26′ is between the output ports of 2-way splitter 14. The communication path between set top box 26″ and 26′″ is between the output ports of 3-way splitter 12. The input 10 of the in-home network is terminated by the external CATV network, and the losses of the various communication paths with the in-home network can become quite high and sometimes over 50 dB. This level of loss seriously reduces data throughput in the in-home network and in many cases prevents the in-home network from working.

Given that no two in-home networks are alike and in most cases there is no clear overview of the network topology, it can be very difficult and time consuming to fix a network when it is showing data loss or reduced speed or even total failure, and thus the correct in-home installation becomes very expensive.

The invention will now be discussed with respect to FIGS. 4 5 and 6. By placing a filter on the common port 30 which passes all signals in the frequency pass band of the network, but reflects frequencies outside this band, the signal loss at each splitter can be reduced. This in FIG. 4, a filter 36 is placed between the input and the common port and as a signal from port 32 progresses through the splitter back upstream to the CATV provider, the signal is reflected at the common port 30 as there is no termination because of the reflecting splitter. The signal loss between port 32 and port 34 is then reduced from the original 30 dB to 40 dB to 2×3.5=7 dB.

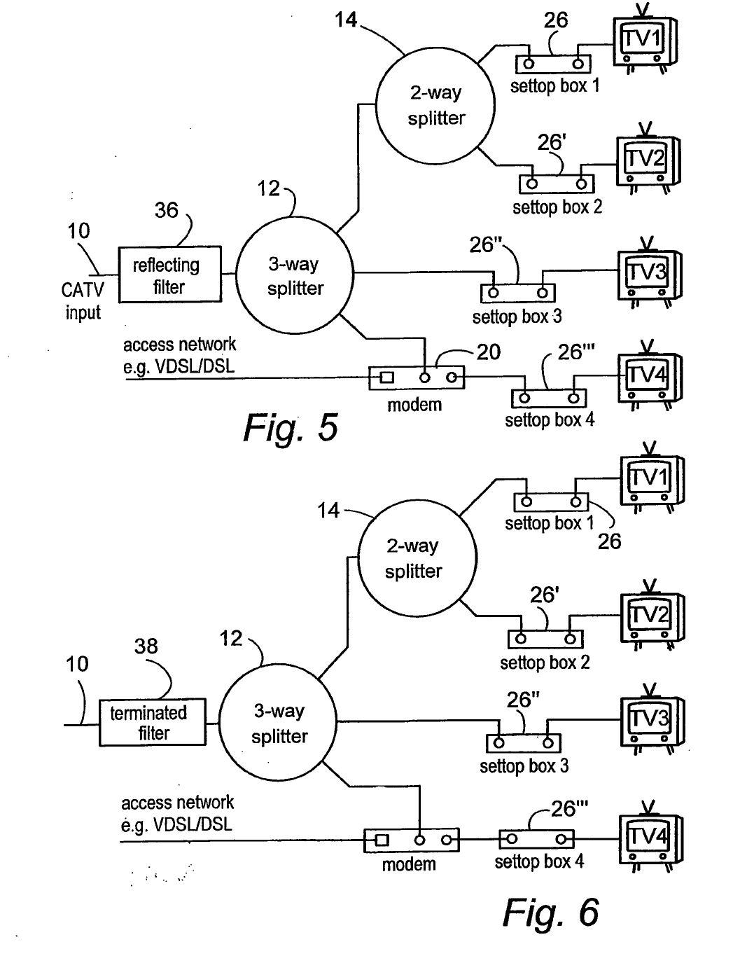

An in-home network using such a filter is shown in FIG. 5. FIG. 5 shows reflecting filter 36 positioned on the path between CATV input 10 and the common port of 3-way splitter 12. This filter 36 at the input of the in-home network reflects signals outside the frequency pass band whilst passing all signals in the frequency pass band. The filter is designed so that the reflected frequency band is the band used by the RF data technology, usually a frequency range of between 3 and 65 MHz or alternatively 900 to 1500 MHz. The filter may be chosen to be one which reflects other frequency bands if appropriate depending on the application. In FIG. 5, the loss of the communication path between set top box 26 and set top box 26′ reduces from 32 dB to 20 dB when compared to the network shown in FIG. 2, with a loss from set top box 26 to set top box 26″ reduced from more than 50 dB to 15 dB. By using filter 36 at the input path, the problems with signal loss within the in-home network can be solved without knowing the precise network topology or the location of the splitters. As long as the reflecting filter 36 is mounted at the input 10, which will be readily accessible and visible, the loss between the various ports within the network will reduce significantly.

The use of the reflecting filter 36 at the input therefore very quickly solves any potential problems in the in-home network with regard to loss, ensuring improved network performance as data speeds will not be reduced and it reduces installation and fault finding time as these are no longer necessary.

Where the in-home coaxial network is used solely for the distribution of data and not for the distribution of signals from a cable television network as well, as in FIG. 6, such a reflecting filter 38 is also of an advantage. Whilst one might suppose that disconnecting the CATV network, leaving the input of the in-home network open would reduce the loss between the various ports as there would then be no termination at the input, this would mean that the input port to the in-home network would radiate and the in-home network would no longer meet regulations regarding signal emission.

By using the terminated filter at the input of the in-home network, the filter reflects all signals outside its frequency pass band, and so the loss between the ports reduces, whilst at the same time the frequency range inside the frequency pass band is terminated resulting in a well screened network. The terminated filter 38 is the same filter as the reflecting filter but at the point where usually the CATV input is mounted (input 10 in FIG. 6) the filter is terminated with a resistor. The value of the resistor is equal to the characteristic impedance of the network and the filter.

While the foregoing is directed to embodiments of the present invention, other and further embodiments of the invention may be devised without departing from the basic scope thereof, and the scope thereof is determined by the claims that follow.

We claim:

1. A coaxial network comprising an input capable of connection to a cable or satellite television signal provider and which is connected to a signal splitting device for communicating a signal to a plurality of outlets in the form of subscriber equipment, wherein a filter is positioned between the input and the signal splitting device, the filter adapted to reflect signals in a frequency band used for data transfer thereby to reduce signal loss.

2. A coaxial network according to claim 1, wherein the filter is adapted to reflect signals inside a frequency range between 3 and 65 MHz or 900 to 1500 MHz.

3. A coaxial network according to claim 1, wherein the filter terminates the input, whilst still reflecting all signals outside the frequency pass band.

4. A coaxial network according to claim 2, wherein the filter terminates the input, whilst still reflecting all signals outside the frequency pass band

5. Use of a filter positioned on an electrical communication path between a cable or satellite television and signal provider and a splitter so as to reflect signals in a frequency band used for data transfer which are outside a frequency pass band of the electrical communication path, thereby to reduce signal loss between outlets.
